(19) United States
(12) Patent Application Publication
(10) Pub. No.: US 2022/0189218 A1
(43) Pub. Date: Jun. 16, 2022

(54) CONTROL DEVICE, SYSTEM, VEHICLE, STORAGE MEDIUM, AND OPERATION METHOD OF CONTROL DEVICE

(71) Applicant: TOYOTA JIDOSHA KABUSHIKI KAISHA, Toyota-shi (JP)

(72) Inventor: Toyokazu NAKASHIMA, Nagoya-shi (JP)

(73) Assignee: TOYOTA JIDOSHA KABUSHIKI KAISHA, Toyota-shi (JP)

(21) Appl. No.: 17/526,304

(22) Filed: Nov. 15, 2021

(30) Foreign Application Priority Data
Dec. 14, 2020 (JP) 2020-207073

(51) Int. Cl. G07C 5/08

(52) U.S. Cl. CPC G07C 5/0808; G07C 5/085

(57) ABSTRACT

A control device includes a storage unit configured to store information and a control unit configured to receive, from another control device pair that has a portion located on a bottom portion of a vehicle and that detects an operation of predetermined equipment, a signal that each control device of the other control device pair outputs when detecting an abnormality, and to store information indicating a predetermined event in the vehicle in the storage unit in response to the signal.

### CROSS-REFERENCE TO RELATED APPLICATION

This application claims priority to Japanese Patent Application No. 2020-207073 filed on Dec. 14, 2020, incorporated herein by reference in its entirety.

### BACKGROUND

### 1. Technical Field

The present disclosure relates to a control device, a system, a vehicle, a storage medium, and an operation method of the control device.

### 2. Description of Related Art

Users who are planning to purchase used vehicles, and dealers going in between resale of vehicles, confirm whether vehicles have encountered trouble such as flooding and so forth, in order to judge resale prices of the vehicles. As an example of a method for detecting flooding of vehicles, Japanese Unexamined Patent Application Publication No. 2020-082766 (JP 2020-082766 A) discloses an example of a submersion sensor.

### SUMMARY

A control device and so forth that enable easy recognition of whether a vehicle has encountered flooding are disclosed below.

A control device according to the first disclosure includes a storage unit that stores information, and a control unit that receives, from another control device pair that includes a portion located on a bottom portion of a vehicle and that detects an operation of predetermined equipment, a signal that each control device of the other control device pair outputs when detecting an abnormality, and stores information indicating a predetermined event in the vehicle in the storage unit in response to the signal.

A computer-readable non-transitory storage medium according to the second disclosure includes a program programmed to cause a control device to execute receiving, from another control device pair that includes a portion located on a bottom portion of a vehicle and that detects an operation of predetermined equipment, a signal that each control device of the other control device pair outputs when detecting an abnormality, and storing information indicating a predetermined event in the vehicle in a storage unit in response to the signal.

An operation method of a control device according to the third disclosure includes receiving, from another control device pair that includes a portion located on a bottom portion of a vehicle and that detects an operation of predetermined equipment, a signal that each control device of the other control device pair outputs when detecting an abnormality, and storing information indicating a predetermined event in the vehicle in a storage unit in response to the signal.

According to the control device and so forth of the present disclosure, easy recognition of whether a vehicle has encountered flooding is enabled.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of a control device;

FIG. 2 is a flowchart showing an example of operation procedures of the control device;

FIG. 3 is a flowchart showing an example of operation procedures of the control device;

FIG. 4 is a flowchart showing an example of operation procedures of the control device; and

FIG. 5 is a flowchart showing an example of operation procedures of the control device.

### DETAILED DESCRIPTION OF EMBODIMENTS

An embodiment will be described below.

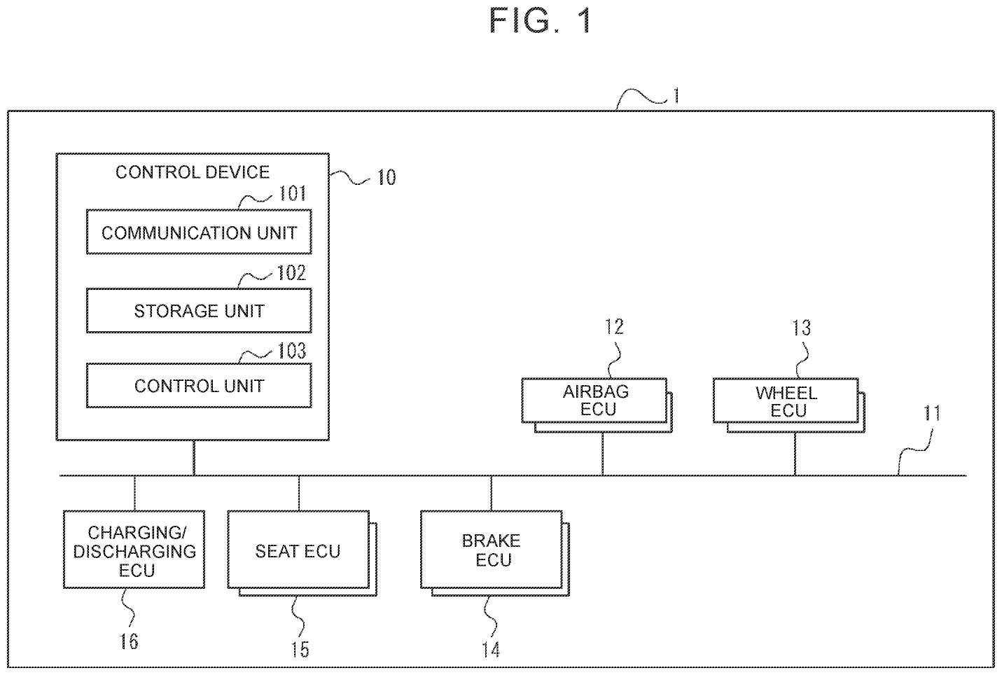

FIG. 1 is a diagram illustrating a configuration example of a control device according to an embodiment. A control device 10 is an information processing device that operates under supply of electric power from a battery of a vehicle 1 that is installed in the vehicle 1 such as a passenger car, a multipurpose vehicle, or the like, and is connected to an in-vehicle network 11. Further connected to the in-vehicle network 11 is equipment such as at least a pair of each of airbag electronic control units (ECUs) 12, wheel ECUs 13, brake ECUs 14, seat ECUs 15, and so forth (hereinafter, each of the pairs of ECUs will be referred to as “ECU pair”). The equipment and devices connected to the in-vehicle network 11 are configured to be capable of communication of information with each other via the in-vehicle network 11. The vehicle control device 10 is an ECU, for example. Alternatively, the control device 10 may be an information terminal device such as an automotive navigation system, a smartphone, a tablet terminal device, a personal computer, or the like, that has a communication interface that is compatible with the in-vehicle network 11. The in-vehicle network 11 is a network conforming to a standard such as Controller Area Network (CAN) or the like. The airbag ECU pair 12 controls and detects operations of airbags located at the right and left seats at the front of the cabin of the vehicle 1, respectively. The wheel ECU pair 13 respectively detects rotation operations of the right and left wheels at the front of the vehicle 1, the right and left wheels at the rear, or one of the right and left wheels at the front and one of the right and left wheels at the rear. The brake ECU pair 14 respectively controls and detects braking operations of the brakes of the right and left wheels at the front of the vehicle 1, the brakes of the right and left wheels at the rear, or one of the brakes of the right and left wheels at the front and one of the brakes of the right and left wheels at the rear. The seat ECU pair 15 respectively controls and detects sliding, ascending/descending, or reclining operations of the right and left seats at the front of the vehicle 1, the right and left seats at the rear, or one of the right and left seats at the front and one of the right and left seats at the rear. When the vehicle 1 is a hybrid vehicle, a charging/discharging ECU 16 for controlling charging/discharging of a battery is connected to the in-vehicle network 11.

The airbag ECU pair 12, the wheel ECU pair 13, the brake ECU pair 14, and the seat ECU pair 15 are each located on the bottom portion of the vehicle body of the vehicle 1, due to the nature and the placement of the respective control objects. Also, the ECU pairs are located with one toward the front of the vehicle 1 and the other toward the rear, or with one toward the right of the vehicle 1 and the other toward the left. The bottom portion of the vehicle 1 includes the bottom portion of the frame of the vehicle 1, and members making up the floor portion of the vehicle body. The bottom portion includes from the lowest portion of the outer portion of the vehicle body of the vehicle 1 to the height of front and rear bumpers. Alternatively, the airbag ECU pair 12, the wheel ECU pair 13, the brake ECU pair 14, and the seat ECU pair 15 may be connected via a floor wire so as to be capable of communication of information with the respective control objects. The floor wire is located on the bottom portion of the vehicle 1, and is covered by a non-waterproof harness, for example. In this case, signal lines from the ECU pairs to the control objects are included in “control device pair”. When detection results exhibit an abnormal value set in advance, the airbag ECU pair 12, the wheel ECU pair 13, the brake ECU pair 14, and the seat ECU pair 15 each store information indicating abnormality detection therein, and output signals indicating abnormality detection. Signals indicating abnormality detection include, besides diagnosis signals, signals output from the ECUs when some sort of malfunction or abnormality is detected. Hereinafter, signals indicating abnormality detection will be referred to as “abnormality detection signals”. Each ECU pair also outputs abnormality detection signals in cases of detecting line breakage, electric leakage, or some other abnormality of the floor wire connected thereto.

In the present embodiment, the control device 10 has a storage unit 102 that stores information, and a control unit 103. The control unit 103 receives abnormality detection signals output from another control device pairs that have portions located at the bottom portion of the vehicle 1 and that detect operations of predetermined equipment, i.e., each of the airbag ECU pair 12, the wheel ECU pair 13, the brake ECU pair 14, and the seat ECU pair 15, when detecting an abnormality, and stores information indicating a predetermined event in the vehicle 1 in the storage unit 102 in response to the abnormality detection signals. The pairs of the airbag ECU pair 12, the wheel ECU pair 13, the brake ECU pair 14, and the seat ECU pair 15 are installed as standard equipment to the vehicle 1, and the reasonable probability of the ECUs making up these pairs outputting abnormality detection signals together is extremely low in a normal collision accident in which impact is applied from one direction side of the vehicle body of the vehicle 1. On the other hand, the main bodies of the airbag ECU pair 12, the wheel ECU pair 13, the brake ECU pair 14, and the seat ECU pair 15, or the floor wire connected to the main bodies, are located at the bottom portion of the vehicle 1, and accordingly there is a high reasonable probability of the main bodies of the pairs of ECUs and the floor wire both becoming immersed and outputting abnormality detection signals due to the vehicle 1 being flooded with water to around several centimeters to 50 centimeters above the floor. Accordingly, the control unit 103 detects an occurrence of flooding as a predetermined event based on the abnormality detection signals output from these ECU pairs, and stores information indicating occurrence of flooding in the storage unit 102. Thus, history of occurrence of flooding is held without providing additional sensors or the like for detecting flooding above the floor or therearound, and this can be read out as appropriate. Accordingly, whether the vehicle 1 has encountered flooding can be conveniently recognized.

Parts of the control device 10 will be described.

A communication unit 101 has a communication module corresponding to one or more wired or wireless standards, to connect to the in-vehicle network 11. For example, the communication unit 101 is connected to the in-vehicle network 11 by a communication module corresponding to a standard such as CAN or the like. The communication unit 101 also exchanges information with a cloud server or the like by a mobile communication module of the vehicle 1 via the network 11. Alternatively, the communication unit 101 may have a communication module corresponding to mobile communication. The communication unit 101 hands abnormality detection signals received from the airbag ECU pair 12, the wheel ECU pair 13, the brake ECU pair 14, the seat ECU pair 15, or the charging/discharging ECU 16, to the control unit 103. Further, the communication unit 101 may include one or more global navigation satellite system (GNSS) receivers, or may have a communication module that is communicable with a GNSS receiver. Examples of GNSS include at least one of the Global Positioning System (GPS), the Quasi-Zenith Satellite System (QZSS), the BeiDou Navigation Satellite System (BDS), Global Navigation Satellite System (GLONASS), and Galileo. The communication unit 101 receives GNSS signals, and hands the received signals to the control unit 103.

The storage unit 102 has, for example, semiconductor memory, magnetic memory, optical memory, or the like. The storage unit 102 functions as a main storage device, an auxiliary storage device, or cache memory, for example. The storage unit 102 stores optional information, control and processing programs, and so forth, used for operation of the control unit 103. The storage unit 102 also stores history of accidents and flooding occurring, as determined by the control unit 103.

The control unit 103 has, for example, one or more general-purpose processors such as a central processing unit (CPU) or the like, or one or more dedicated processors that are specialized for particular processing. Alternatively, the control unit 103 may have one or more dedicated circuits such as a field-programmable gate array (FPGA), an application specific integrated circuit (ASIC), or the like. The control unit 103 carries out operations of the present embodiment by operating following control and processing programs, or operating following operation procedures implemented in circuitry and so forth.

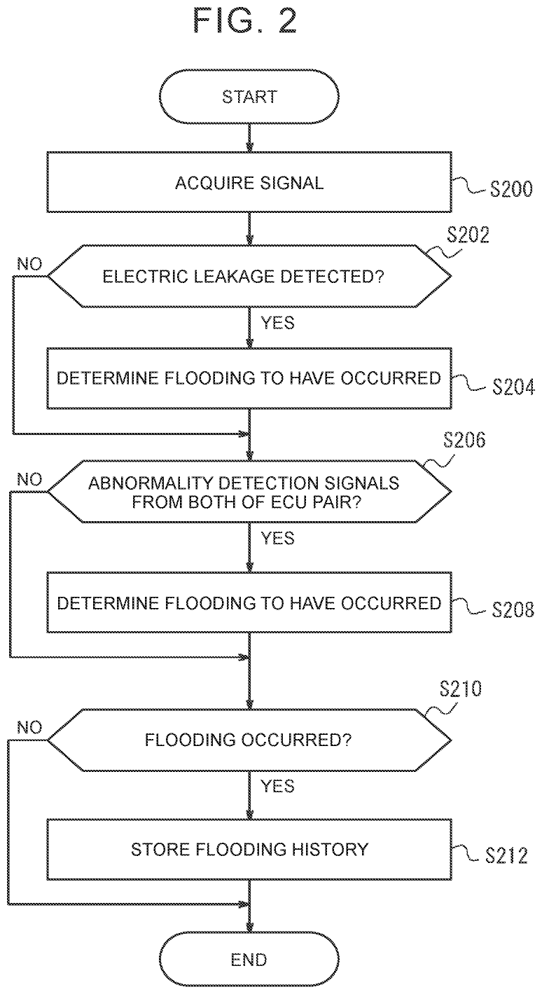

FIG. 2 is a flowchart for describing an example of operation procedures of the control device 10 according to the present embodiment. The operation procedures in FIG. 2 are executed by the control unit 103 at an optional cycle (e.g., at intervals of several seconds to several minutes) when power is provided to the control device 10 by the ignition of the vehicle 1 being turned on, and the control device 10 is operating, for example. Note that the procedures shown in FIG. 2 are procedure examples for when the vehicle 1 is a hybrid vehicle. When the vehicle 1 is not a hybrid vehicle, i.e., when the vehicle 1 does not have the charging/discharging ECU 16, steps S202 and S206 are omitted.

In step S200, the control unit 103 acquires various types of signals, including abnormality detection signals, from the ECUs of the vehicle 1. The control unit 103 receives abnormality detection signals output from each ECU of the airbag ECU pair 12, the wheel ECU pair 13, the brake ECU pair 14, the seat ECU pair 15, and the charging/discharging ECU 16, via the communication unit 101. Note however, that when the vehicle 1 is not a hybrid vehicle, i.e., when the vehicle 1 does not have the charging/discharging ECU 16, there are no abnormality detection signals from the charging/discharging ECU 16.

In step S202, the control unit 103 determines whether electric leakage has been detected by the charging/discharging ECU 16. For example, when acquiring abnormality detection signals indicating electric leakage from the charging/discharging ECU 16, the control unit 103 determines that electric leakage has been detected (Yes in step S202), and advances to step S204. Then in step S204, the control unit 103 determines that flooding has occurred. On the other hand, when no abnormality detection signals indicating electric leakage are acquired, the control unit 103 determines that no electric leakage has been detected (No in step S202), and advances to step S206 without executing step S204.

In step S206, the control unit 103 determines whether abnormality detection signals have been acquired from both ECUs of the ECU pair. For example, when abnormality detection signals are acquired from both ECUs of the pair of ECUs in the airbag ECU pair 12, the wheel ECU pair 13, the brake ECU pair 14, or the seat ECU pair 15 (Yes in step S206), the control unit 103 advances to step S208. In this case, the reasonable probability of both ECUs of the ECU pairs outputting abnormality detection signals is low in a normal collision accident or the like, but the reasonable probability that both ECUs of the ECU pairs that have become immersed due to flooding are outputting abnormality detection signals together is high. Accordingly, in step S208, the control unit 103 determines that flooding has occurred. On the other hand, when no abnormality detection signals are acquired from both ECUs of any of the ECU pairs (No in step S206), the control unit 103 advances to step S210 without executing step S208.

In step S210, the control unit 103 determines whether flooding has occurred. For example, when determining in step S204 or in step S208 that flooding has occurred (Yes in step S210), the control unit 103 advances to step S212. Then in step S212, the control unit 103 stores history of occurrence of flooding in the storage unit 102. The control unit 103 then ends the procedures in FIG. 2. On the other hand, when not determining that flooding has occurred, the control unit 103 ends the procedures of FIG. 2 without executing step S212.

According to the above-described procedures, history of occurrence of flooding can be held without providing additional sensors or the like for detecting flooding.

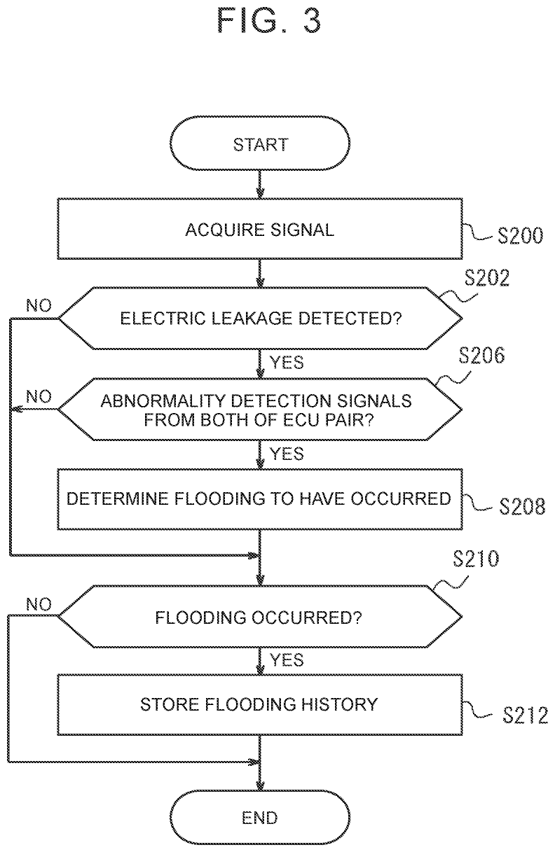

FIG. 3 shows operation procedures according to a modification for when the vehicle 1 is a hybrid vehicle. The procedures in FIG. 3 are the same as the procedures in FIG. 2 with exception of the following points. In FIG. 3, the control unit 103 executes step S206 under the conditions of determining that electric leakage is detected in step S202 (Yes in step S202). On the other hand, when it is not determined that electric leakage is detected in step S202 (No in step S202), the control unit 103 advances to step S210 without executing steps S206 and S208.

In FIG. 3, control unit 103 determines that flooding has occurred under the conditions that electric leakage detection, and abnormality detection by both ECUs of an ECU pair, are satisfied. Accordingly, the precision of determination of flooding occurring is higher as compared to the case in FIG. 2.

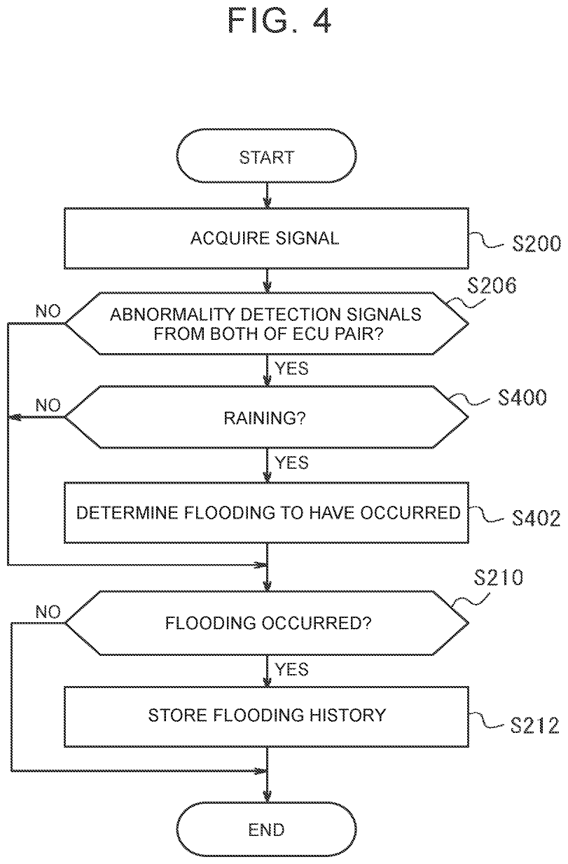

FIG. 4 shows operation procedures according to another modification for when the vehicle 1 is not a hybrid vehicle. The procedures in FIG. 4 are the same as the procedures in FIG. 2 with exception of the following points. In FIG. 4, steps S202, S204, and S208 are omitted. Also, in FIG. 4, when Yes in step S206, steps S400 and S402 are executed. Further, when No in step S206, the control unit 103 advances to step S210 without executing steps S400 and S402.

In step S400, the control unit 103 determines whether there is rainfall. For example, the control unit 103 acquires weather information at the current position of the vehicle 1 from a cloud server or the like that distributes weather information, via the communication unit 101, and determines whether there is rainfall. When determining that there is rainfall (Yes in step S400), the control unit 103 determines in step S402 that flooding has occurred. On the other hand, when determining that there is no rainfall (No in step S400), the control unit 103 advances to step S210 without executing step S402.

In FIG. 4, control unit 103 determines that flooding has occurred under the conditions that abnormality detection by both ECUs of an ECU pair, and rainfall, are satisfied. The reasonable probability of flooding is higher when raining than when not raining. Accordingly, the precision of determination of flooding occurring is higher as compared to the case in FIG. 2.

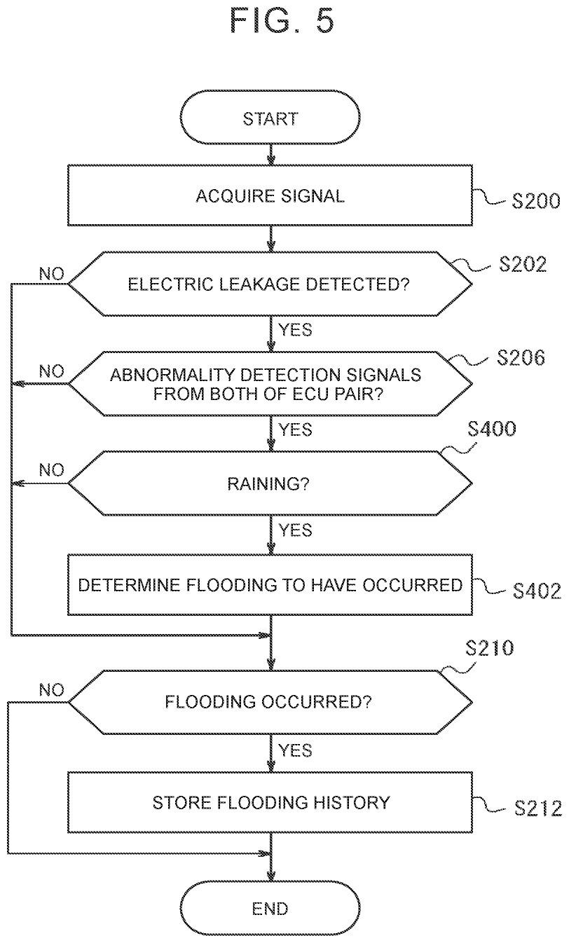

FIG. 5 shows operation procedures according to yet another modification for when the vehicle 1 is a hybrid vehicle. The procedures in FIG. 5 are the same as the procedures in FIG. 3 with exception of the following points. In FIG. 5, steps S204 and S208 are omitted. Also, in FIG. 5, when Yes in step S206, steps S400 and S402 are executed. Further, when No in step S202, and when No in step S206, the control unit 103 advances to step S210 without executing steps S400 and S402.

In FIG. 5, control unit 103 determines that flooding has occurred under the conditions that all of electric leakage detection, abnormality detection by both ECUs of an ECU pair, and rainfall, are satisfied. Accordingly, the precision of determination of flooding occurring is higher as compared to the cases in FIGS. 2 and 3.

Part or all of the operations of the control device 10 according to the present embodiment may be executed by a server computer, for example, that is capable of information communication with the control device 10 via mobile communication.

History of flooding stored in the storage unit 102 by the procedures in FIGS. 2 through 5 can be read out as appropriate using an optional interface. For example, the user can read flooding history out from the storage unit 102 of the control device 10 via the in-vehicle network 11 by operating a terminal device capable of being connected to the in-vehicle network 11. Also, when the control device 10 is configured of an information processing device provided with a user interface, such as an automotive navigation system or the like, the user can read flooding history out from the storage unit 102 by operating the user interface of the information processing device. Alternatively, when a server device has part or all of the storage unit 102, the user may read flooding history out from the server device by operating an information processing device such as a personal computer or the like that is connected to the server device via a network, such as the Internet, for example.

According to the present embodiment, a resale dealer, for example, can easily comprehend whether there has been flooding of the vehicle 1. History of flooding is managed by the control device 10 installed in the vehicle 1, and accordingly history of flooding can be retained in the vehicle 1 itself, even when maintenance records of the vehicle 1 and so forth are incomplete.

Processing and control programs that define operations of the control device 10 may be stored in a storage unit of an optional server device to which the control device 10 is capable of connecting, and be downloaded to the control device 10, or may be stored in a portable and non-transitory recording or storage medium that is readable by the control device 10, and read by the control device 10 from the medium.

Although the embodiment has been described above based on the drawings and examples, it should be noted that one skilled in the art can easily make various types of modifications and alterations based on the present disclosure. Accordingly, it should be noticed that all such modifications and alterations are encompassed by the scope of the present disclosure. For example, the functions and so forth included in the means, the steps, and so forth, may be rearranged insofar as there is no logical contradiction, and a plurality of means, steps, and so forth may be combined into one, or may be divided.

What is claimed is:

1. A control device comprising:
a storage unit configured to store information; and
a control unit configured to receive, from another control device pair that includes a portion located on a bottom portion of a vehicle and that detects an operation of predetermined equipment, a signal that each control device of the other control device pair outputs when detecting an abnormality, and to store information indicating a predetermined event in the vehicle in the storage unit in response to the signal.

2. The control device according to claim 1, wherein one control device of the other control device pair is located toward a front of the vehicle, and the other is located toward a rear of the vehicle.

3. The control device according to claim 2, wherein the predetermined equipment includes a brake, a seat, or a wheel.

4. The control device according to claim 1, wherein one control device of the other control device pair is located toward a right side of the vehicle, and the other is located toward a left side of the vehicle.

5. The control device according to claim 4, wherein the predetermined equipment includes an airbag, a brake, a seat, or a wheel.

6. The control device according to claim 1, wherein the control unit is configured to store information indicating the predetermined event in the storage unit, with rainfall as a further condition of performing the storing.

7. The control device according to claim 1, wherein the control unit is configured to output, from the storage unit, information indicating the predetermined event, as history of flooding of the vehicle, in response to predetermined input.

8. A system comprising:
the control unit according to claim 1; and
another control device pair.

9. A vehicle comprising the control unit according to claim 1.

10. A computer-readable non-transitory storage medium comprising a program programmed to cause a control device to execute receiving, from another control device pair that includes a portion located on a bottom portion of a vehicle and that detects an operation of predetermined equipment, a signal that each control device of the other control device pair outputs when detecting an abnormality, and storing information indicating a predetermined event in the vehicle in a storage unit in response to the signal.

11. The storage medium according to claim 10, wherein one control device of the other control device pair is located toward a front of the vehicle, and the other is located toward a rear of the vehicle.

12. The storage medium according to claim 11, wherein the predetermined equipment includes a brake, a seat, or a wheel.

13. The storage medium according to claim 10, wherein one control device of the other control device pair is located toward a right side of the vehicle, and the other is located toward a left side of the vehicle.

14. The storage medium according to claim 13, wherein the predetermined equipment includes an airbag, a brake, a seat, or a wheel.

15. The storage medium according to claim 10, wherein in storing information indicating the predetermined event in the storage unit, information indicating the predetermined event in the vehicle is stored in the storage unit, with rainfall as a further condition of performing the storing.

16. The storage medium according to claim 10, wherein the program is programmed to cause the control device to execute outputting, from the storage unit, information indicating the predetermined event, as history of flooding of the vehicle, in response to predetermined input.

17. An operation method of a control device, the operation method comprising receiving, from another control device pair that includes a portion located on a bottom portion of a vehicle and that detects an operation of predetermined equipment, a signal that each control device of the other control device pair outputs when detecting an abnormality, and storing information indicating a predetermined event in the vehicle in a storage unit in response to the signal.

18. The operation method according to claim 17, wherein one control device of the other control device pair is located toward a front of the vehicle, and the other is located toward a rear of the vehicle.

19. The operation method according to claim 17, wherein one control device of the other control device pair is located toward a right side of the vehicle, and the other is located toward a left side of the vehicle.

20. The operation method according to claim 17, wherein in storing information indicating the predetermined event in the storage unit, information indicating the predetermined event in the vehicle is stored in the storage unit, with rainfall as a further condition of performing the storing.
